(19) United States
(12) Patent Application Publication
(10) Pub. No.: US 2019/0299479 A1
(43) Pub. Date: Oct. 3, 2019

(54) ROUND KNIFE WITH CONCENTRIC MATERIAL REJUVENATION

(71) Applicant: Dienes Werke für Maschinenteile GmbH & Co. KG, Overath (DE)

(72) Inventor: Rudolf Supe-Dienes, Overath (DE)

(21) Appl. No.: 16/366,721

(22) Filed: Mar. 27, 2019

(30) Foreign Application Priority Data
Mar. 28, 2018 (DE) DE102018107495.6

(51) Int. Cl. B26D 1/14; B26D 1/00

(52) U.S. Cl. CPC B26D 1/141; B26D 2001/0053; B26D 2001/0046; B26D 1/0006

(57) ABSTRACT

The exemplary embodiments relate to a circular blade (1) having two end faces (2) and a peripheral cutting edge (3). The blade includes two axial sides (12, 14). In at least one axial side at least one material tapering (4) is formed running concentric to the cutting edge (3), so that a thickness of the circular blade (1) decreases radially outwardly towards a minimum tapering thickness (5) due to the geometric formation of the material tapering (4). The minimum tapering thickness (5) is dimensioned so that the circular blade (1) cannot be broken at the material tapering, so that a successor cutting edge can be produced by grinding only in the region of the material tapering.

### TECHNICAL FIELD

The exemplary arrangement relates to a circular blade having two end faces and a peripheral cutting edge. The exemplary arrangements relate in particular to circular blades for a longitudinal cutting machine or for a roller cutting machine.

### BACKGROUND

Longitudinal cutting machines usually comprise a blade holder with a lowering device, which holder carries a blade head. The blade head holds a circular blade with a peripheral cutting edge as a so-called upper blade and drives this upper blade as necessary. The longitudinal cutting machine further comprises a lower blade which is associated with the upper blade. By means of the lowering device, the upper blade can be brought to the lower blade at least in two spatial directions, wherein the material to be cut is located between the upper blade and the lower blade. As a rule, the upper blade is set in rotation through the friction with the driven lower blade. However, it is also known for the upper blade to be actively driven. Both the upper blade and the lower blade are each attached directly or by means of a hub to a shaft or axis, wherein the lower blade and/or upper blade is fixed by means of a holding element on the hub.

In roller cutting machines, the rotary driven circular blade is guided, for example, along a circular path through paper rolls, whereby the paper rolls are trimmed in their length. Such machines are also known as a “log saw machine” as described in US 2014/331838 A1. For example, a plurality of relatively short paper rolls is cut from a paper roll several meters long.

When such a circular blade is dulled, the cutting machine can be stopped, the circular blade can be removed from the hub and then reground. Alternatively, however, the circular blade can be reground within the machine. After repeated regrinding, the circular blade should usually no longer be used, since the blade increases in thickness at its midpoint and the cutting edge can no longer be ground or can only be reground with great effort, on the worn peripheral side of the circular blade.

In conventional circular blades, the thickness of the circular blade increases from the peripheral cutting edge towards the blade midpoint. When regrinding, it must be ensured that the end faces adjoining the peripheral cutting edge have a predetermined alignment and a predetermined angle to each other. A considerable effort is necessary for the required material removal to ensure this alignment and maintenance of this angle between the end faces with repeated regrinding.

Therefore, a circular blade is known from DE 10 2016 104227 B4, in which an outer ring segment comprising the peripheral cutting edge can be separated from the central blade segment at a predetermined breaking point arranged concentrically to the peripheral cutting edge, so that a cutting edge can be reground at the break-off edge. However, it has now been found that in some applications with very large circular blades, the circular blade does not run evenly and in which a maximum thickness is not exceeded, due to weakening of the material at the predetermined breaking point.

### SUMMARY

The object of the exemplary embodiment is therefore to at least partially solve the problems described with reference to the prior art and in particular to provide a circular blade in which a sharp cutting edge can be produced with reasonable effort even after repeated regrinding.

Improvements are achieved by a circular blade having the features of the independent claims. Further advantageous features of the exemplary circular blade are specified in the dependent claims and in the description, wherein individual features of the advantageous developments are combined with each other in a technically meaningful manner.

Improvements are achieved in particular by a circular blade having two end faces and a peripheral cutting edge, wherein in at least one end face at least one material tapering running concentric to the cutting edge is formed, so that a thickness of the circular blade decreases radially outward towards a minimum tapering thickness due to the geometric formation of the material tapering, and in particular after the minimum tapering thickness, increases again over a short radial distance outward. The minimum tapering thickness is dimensioned so that the circular blade is not breakable at the material tapering, so that a cutting edge can be produced in the region of the material tapering by, for example, peripheral grinding, without breaking.

The exemplary embodiment proposes that the thickness of the circular blade does not increase too much radially inward even after the wear of the original peripheral cutting edge caused by repeated regrinding, and a sharp cutting edge can be ground when the minimum tapering thickness is reached in this region. Due to the formation of the material tapering, the alignment and the angle of the end faces adjacent to the new cutting edge are substantially predetermined at the minimum tapering thickness and can be reground with little material removal. This eliminates the effort of regrinding the end faces in regions in which the original blade was relatively thick. At the same time, due to the sufficient material thickness in the region of the minimum tapering thickness, it is ensured that the peripheral cutting edge runs stable and quiet even during the operation of a longitudinal cutting machine.

For this purpose, the minimum tapering thickness in exemplary arrangements is more than 0.5 mm [millimeter], and in other arrangements more than 0.7 mm and in other exemplary arrangements at least 1 mm.

In contrast, the thickness of the circular blade in a central region is in particular at least 1 mm, in other exemplary arrangements at least 3 mm and in other arrangements at least 5 mm.

In exemplary arrangements, the circular blade has at least two, and in other exemplary arrangements, more than two material taperings arranged concentrically with one another, each having a minimum tapering thickness. For example, the total diameter of the original circular blade can be 1 m, wherein a minimum tapering thickness of a first material tapering is formed in the range of 85 to 95 cm in diameter and a minimum tapering thickness of a second material tapering is formed in the range of 75 to 85 cm in diameter.

The material taperings formed, for example, as recesses can be arranged on only one axial side of the circular blade, but in other exemplary arrangements the material taperings are formed in the form of recesses on both axial sides of the circular blade, which are shaped in particular mirror-image to each other.

In an exemplary embodiment, the transverse thickness of the circular blade in axial cross section decreases evenly radially outwards toward the minimum tapering thickness in the region of the at least one material tapering, so that an angle in some embodiments not greater than 15°, in other embodiments not greater than 12° and in other embodiments not great than 10° between the two end faces is enclosed in the region of the material tapering.

In exemplary arrangements the end faces of the circular blade enclose an angle towards the peripheral cutting edge, which angle has the same size as the angle enclosed by the end faces in the region of the material tapering.

In one exemplary embodiment, the cutting edge is formed symmetrically to a central attachment region of the circular blade. In this embodiment, the end faces are in axial cross-section inclined towards each other, wherein the inclination of the end faces with respect to the axis of rotational symmetry of the circular blade which is transverse to the axis of rotation of the blade, are directed towards each other and meet at the cutting edge. Such circular blades are also referred to as burst cutting blades.

In an alternative embodiment, in axial cross-section the cutting edge can be configured asymmetrically offset from a central attachment region of the blade. The end faces are in this case in particular inclined with respect to the axis of rotational symmetry of the circular blade in the same direction. The cutting edge is thus arranged relative to the axis of rotation, offset in the axial direction from the attachment region. Such circular blades are also referred to as a disc knife.

In particular, exemplary embodiments also relate to a longitudinal cutting machine or a roller cutting machine having a blade according to the exemplary embodiments.

The exemplary embodiments and the technical environment are explained below by way of examples with reference to the drawing Figures.

### BRIEF DESCRIPTION OF DRAWINGS

FIG. 1 is an axial cross-section view of an exemplary circular blade designed as a burst cutting blade

FIG. 2 is an axial cross-section view of an exemplary circular blade designed as a disc knife

FIG. 3 is a plan view of an exemplary first circular axial side of an exemplary circular blade

### DETAILED DESCRIPTION

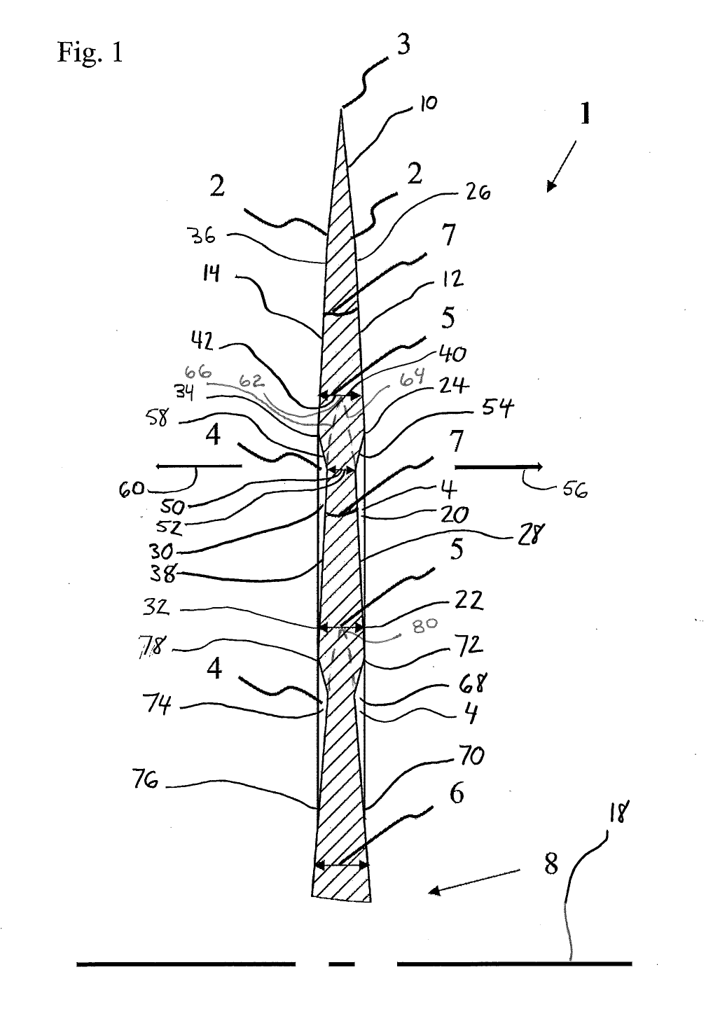

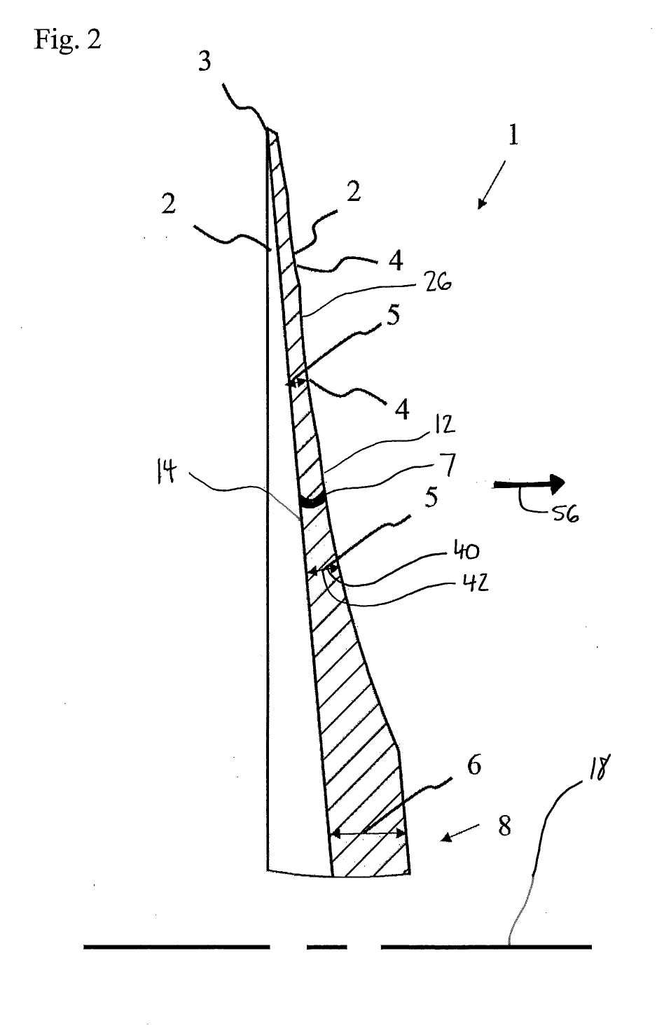

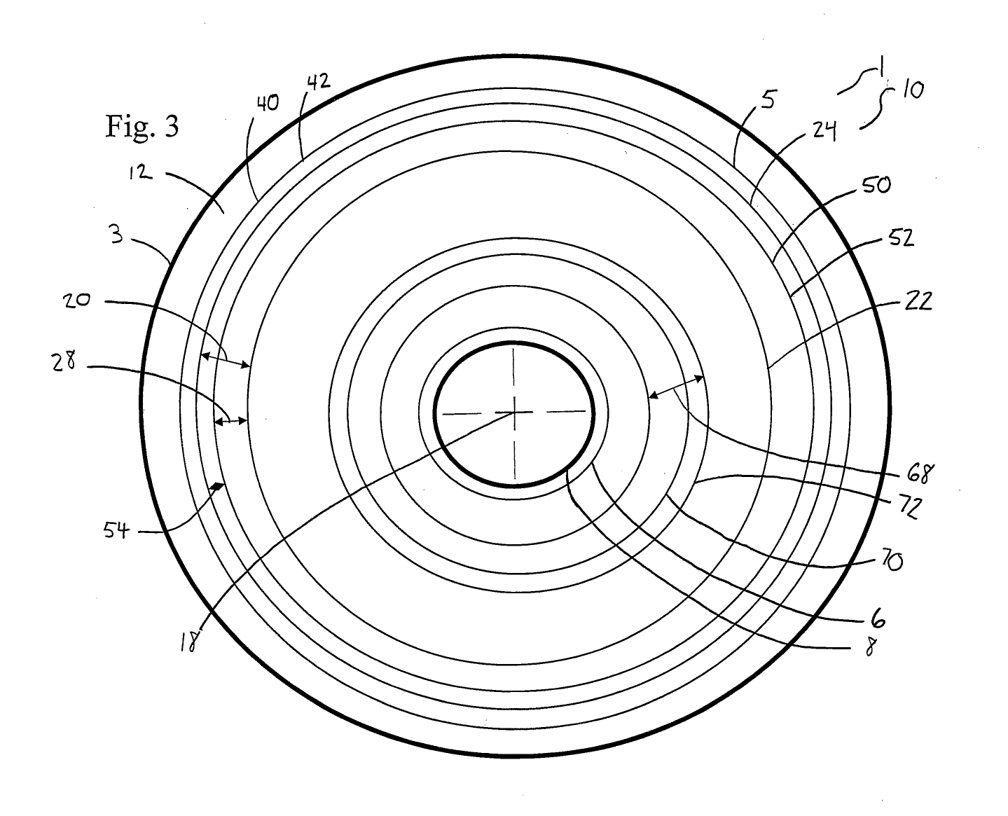

FIGS. 1 and 2 each show an axial cross-section through half of a respective exemplary circular blade 1. The circular blade of FIG. 1 is configured to cut material by rotation about an axis 18. The circular blade includes a circular body 10. The circular body 10 of the circular blade 1 has two opposed end faces 2. The circular body 10 also includes a first axial side 12 and a second axial side 14 which include the respective end faces. The first axial side 12 is also shown in the plan-view of FIG. 3. The exemplary circular body 10 includes a fastening region 8 also referred to herein as a central fastening region 8, that is concentric with the axis 18. The circular body 10 also includes a peripheral cutting edge 3 that is radially disposed outward from the axis 18. The circular body further includes an exemplary circular recess 20 also referred to as material tapering 4. The circular recess 20 extends into the body 10 on the first axial side 12.

As shown best in FIG. 3, the exemplary circular recess 20 is coaxial with the axis 18. The circular recess is 20 radially intermediate of the central fastening region 8 and the cutting edge 3. The circular recess 20 extends radially between an inner recess radius 22 and an outer recess radius 24.

In some embodiments, as shown in FIG. 1, the second axial side 14 includes a further circular recess 30 that extends into the circular body 10 on the second axial side 14. The further circular recess 30 is coaxial with the axis 18 and is radially intermediate of the central fastening region 8 and the cutting edge 3. The further circular recess 30 extends radially between a further inner recess radius 32 and a further outer recess radius 34. The further inner recess radius 32 of the second axial side corresponds to the inner recess radius 22 of the first axial side, and the further outer recess radius 34 of the second axial side 14 corresponds to the outer recess radius 24 of the first axial side 12.

When viewing the exemplary embodiment of the blade configuration of FIG. 2 in axial cross-section, as shown in FIG. 2, the first axial 12 side includes a tapered end face 26 that bounds the circular body 10, and that extends to the cutting edge 3. The tapered end face 26 extends continuously closer to the inclined second axial side 14 with radially outward proximity to the cutting edge 3.

In other exemplary embodiments, as shown in FIG. 1, the second axial side includes a further tapered end face 36 that bounds the body 10 of the circular blade 1 and that extends to the cutting edge 3. The further tapered end face 36 extends continuously closer to the first axial side 12 with radially outward proximity to the cutting edge 3.

In reference to FIG. 1, the exemplary embodiment further includes the material taperings 4 which correspond to the circular recesses 20, 30 that are formed in the circular blade 1 so that a thickness 6, also referred to as a central fastening region thickness 6, of the circular blade 1 decreases evenly radially outward toward a respective minimum tapering thickness 5. Minimum tapering thickness 5 is also referred to herein as the taper thickness 5.

In exemplary arrangements, the first axial side 12 of the circular body 10 includes a tapered recess face 28 that bounds the first circular body 10 within the circular recess 20 in axial cross-section as shown in FIG. 1. The exemplary tapered recess face 28 extends continuously closer to the second axial side 14 from the inner recess radius 22 with radially outward proximity to the outer recess radius 24. The minimum tapering thickness 5 in this case is dimensioned relative to the tapered recess face so that an external segment of the circular blade 1 cannot be broken off from a central segment on the area of the material tapering 4.

In an exemplary embodiment, as shown in FIG. 1, in axial cross-section the second axial side 14 also includes a further tapered recess face 38 that bounds the circular body 10 within the further circular recess 30 of the second axial side. The further tapered recess face 38 of the second axial side extends continuously closer to the first axial side 12 from the further inner recess radius 32 with radially outward proximity to the further outer recess radius 34.

In the exemplary embodiment, the taper thickness 5 which is also referred to as the minimum tapering thickness 5, comprises a body thickness of the circular body 10 that is parallel to the blade rotational axis 18. The circular body 10 includes the taper thickness 5 at a taper thickness radius 42 that is disposed radially intermediate of the outer recess radius 24 and the cutting edge 3. As shown in FIG. 1, the exemplary circular body is configured such that each of the first axial side 12 and the second axial side 14 extends continuously closer to the respective opposed axial side radially outward from the taper thickness radius 42 with radially outward proximity to the cutting edge 3. The taper thickness 5 is also the thickness of the circular body 10 at the inner recess radius 22.

In the exemplary embodiment of FIG. 1, the central fastening region thickness 6 is the thickness of the circular body radially inward of the inner recess radius 22 and parallel to the axis 18. In the exemplary arrangement the central fastening region thickness 6 is greater than the taper thickness 5.

Again referring to FIG. 1, the exemplary embodiment is configured such that the tapered recess face 28 of the first axial side 12 and the further tapered recess face 38 of the second axial side 14 extend relative to one another at a convergent angle 7 also referred to herein as angle 7, in a range of 10° to 15° in the radially outward direction. In reference to FIG. 2, in alternative embodiments the circular body 10 may be configured such that only the tapered recess face 28 of the first axial side of the body of the blade extends relative to the second axial side 14 at a convergent angle 7 in a range of 10° to 15° in the radially outward direction.

The convergent angle 7 of the embodiment shown in FIG. 1, between the tapered recess face 28 and the further tapered recess 38 in the region of the material taperings 4, which correspond to circular recesses 20 and 30, are dimensioned so that they correspond to the convergent angle 7 between the tapered end face 26 and the further tapered end face 36, which angle is formed to be convergent radially outward towards the peripheral cutting edge 3.

The exemplary embodiment of FIG. 1 is configured such that the tapered recess face 28 and the further tapered recess face 38 terminate at a minimum recess thickness radius 50. As shown in FIG. 1, the circular body 10 has a minimum recess thickness 52 at the minimum recess thickness radius 50. The minimum recess thickness 52 has a body thickness parallel to the axis 18 that is less than the taper thickness 5.

In the exemplary embodiment shown in FIG. 1, an additional tapered recess face 54 extends in the recess 20 radially outward and in a first axial direction 56 parallel to the axis 18 from the minimum recess thickness radius 50 to the outer recess radius 24. The circular body also includes a further additional tapered recess face 58 that extends in the further recess 30 and in a second axial direction 60 parallel to the axis and opposed of the first axial direction from the minimum recess thickness radius 50 to the further outer recess radius 34. In alternative embodiments, first axial side 12 of the circular body only includes the additional tapered recess face 54 that extends in the recess 20 radially outward in an axial direction parallel to the axis from the minimum recess thickness radius 50 to the outer recess radius 24.

In exemplary arrangements once the peripheral cutting edge 3 is dulled, the circular blade 1 can first be reground several times. Such regrinding of the original cutting edge 3 is no longer economically viable when the cutting edge 3 must be reground in a region in which the circular blade 1 is relatively thick in a direction parallel to axis 18. Through the formation of the material taperings 4 (circular recesses), an economically viable reconditioning of the circular blade 1 is available even after repeated regrinding, since a successor cutting edge can be produced in the region of the relatively thin material tapering 4, without the end faces 2 (tapered end faces 26 and 36) having to be reground with great effort radially inward where the blade has greater thickness.

In the exemplary arrangement, the body 10 of the circular blade 1 is configured to be ground to a successor cutting edge 62, shown in phantom, that extends radially outward from the minimum recess thickness 52 after wearing and regrinding of the cutting edge 3 is no longer reasonably feasible. The circular body 10 of the circular blade 1 also includes a successor tapered end face 64 that extends continuously closer to the second axial side 14 with radially outward proximity to the successor cutting edge 62. The circular body further includes a successor further tapered end face 66 that extends continuously closer to the first axial side 12 with radially outward proximity to the successor cutting edge 62.

Additionally, the successor tapered end face 64 includes the tapered recess face 28, and the successor further tapered end face 66 includes the further tapered recess face 38. In exemplary embodiments, the successor tapered end face 64 extends continuously closer to the second axial side 14 with radially outward proximity to the successor cutting edge 62, and the successor tapered end face includes the tapered recess face 28.

In the exemplary embodiment as shown in FIG. 1, the circular body 10 includes an additional circular recess 68 that extends into the circular body 10 on the first axial side 12. The additional circular recess 68 is coaxial with the axis 18, is radially intermediate of the central fastening region 6 and the inner recess radius 22, and extends radially between an additional inner recess radius 70 and an additional outer recess radius 72. The circular body also includes a further additional circular recess 74 that extends into the circular body 10 on the second axial side 14. The further additional circular recess 74 is coaxial with the axis 18, is radially intermediate of the central fastening region 8 and the further inner recess radius 32, and extends radially between a further additional inner recess radius 76 and a further additional outer recess radius 78. The additional circular recess 68 and the further additional circular recess 74 are configured to be ground to an additional successor cutting edge 80 shown in phantom in the same manner as the circular recess 20 and the further circular recess 30, after the successor cutting edge has been repeatedly worn and reground to the point where regrinding is no longer feasible.

In some embodiments, the cutting edge 3 is arranged symmetrically in axial cross-section to a central fastening region 8 of the circular blade 1, as shown in FIG. 1. In comparison, FIG. 2 shows an alternative exemplary cutting edge 3 arranged axially offset relative to the central fastening region 8 of the circular blade 1.

In the exemplary circular blade according to FIG. 1, the material taperings 4 (circular recesses) are formed on both the first axial side 12 and the second axial side 14. In the exemplary circular blade according to FIG. 2, the alternative material taperings 4 circular recess 20) are formed only on one end face 2 or one axial side. In the exemplary arrangement of FIG. 2, the axial side 2 is inclined relative to the radial direction to provide the asymmetrical configuration shown. The end face 2, or axial side opposite the end face having the material taperings 4, is configured flat. In example arrangements such as is shown in FIG. 2, the flat end face extends radially outward and in axial cross-section at an acute angle relative to the axis 18 so that the cutting edge 3 is disposed in the axial direction from the central fastening region 8 adjacent to the axis 18. Of course the configurations shown in the Figures are exemplary and the principles described herein may be used in numerous other blade configurations.

Thus, the example embodiments achieve improved operation, eliminate difficulties encountered in the use of prior devices and systems, and attain the useful results described herein.

In the foregoing description, certain terms have been used for brevity, clarity and understanding. However, no unnecessary limitations are to be implied therefrom because such terms are used for descriptive purposes and are intended to be broadly construed. Moreover, the descriptions and illustrations herein are by way of examples and the new and useful features are not limited to the exact features shown and described.

Further, in the following claims, any feature described as a means for performing a function shall be construed as encompassing any means known to those skilled in the art as being capable of carrying out the recited function, and shall not be deemed limited to the particular means shown or described for performing the recited function in the foregoing description or mere equivalents thereof.

Having described the features, discoveries and principals of the exemplary embodiments, the manner in which they are constructed and operated, and the advantages and useful results attained; the new and useful structures, devices, elements, arrangements, parts, combinations, systems, equipment, operations, methods, processes and relationships are set forth in the appended claims.

List Of Reference Numbers

| | |
|---|---|
| 1 | circular blade |
| 2 | end face |
| 3 | cutting edge |
| 4 | material tapering |
| 5 | minimum tapering thickness/ |
| | taper thickness |
| 6 | thickness/central fastening |
| | region thickness |
| 7 | angle/convergent angle |
| 8 | fastening region |
| 10 | circular body |
| 12 | first circular axial side |
| 14 | second circular axial side |
| 18 | axis |
| 20 | circular recess |
| 22 | inner recess radius |
| 24 | outer recess radius |
| 26 | tapered end face |
| 28 | tapered recess face |
| 30 | further circular recess |
| 32 | further inner recess radius |
| 34 | further outer recess radius |
| 36 | further tapered end face |
| 38 | further tapered recess face |
| 42 | taper thickness radius |
| 50 | minimum recess thickness |
| | radius |
| 52 | minimum recess thickness |
| 54 | additional tapered recess face |
| 56 | first axial direction |
| 58 | further additional tapered |
| | recess face |
| 60 | second axial direction |
| 62 | successor cutting edge |
| 64 | successor tapered end face |
| 66 | successor further tapered end |
| | face |
| 68 | additional circular recess |
| 70 | additional inner recess radius |
| 72 | additional outer recess radius |
| 74 | further additional circular |
| | recess |
| 76 | further additional inner |
| | recess radius |
| 78 | further additional outer |
| | recess radius |
| 80 | additional successor cutting |
| | edge |

I claim:

1. Apparatus comprising:
a circular blade (1) having a body (10) with two circular axial sides (12, 14) and
a peripheral cutting edge (3),
wherein at least in one axial side (12), at least one material tapering (4) extends that runs concentric with the cutting edge (3),
so that a thickness of the circular blade (1) decreases radially outwardly towards a minimum tapering thickness (5) due to the geometric formation of the at least one material tapering (4),
wherein the minimum tapering thickness (5) is dimensioned so that the circular blade (1) cannot be broken at the at least one material tapering (4),
so that a subsequent cutting edge can be produced by grinding only in the region of the at least one material tapering (4).

2. The apparatus according to claim 1,
wherein the minimum tapering thickness (5) is more than 0.5 mm.

3. The apparatus according to claim 2,
wherein the minimum tapering thickness (5) is at least 1 mm.

4. The apparatus according to claim 3,
wherein a plurality of material taperings (4) are arranged concentrically with each other and the peripheral cutting edge (3).

5. The apparatus according to claim 4,
wherein in axial cross-section a thickness (6) of the circular blade (1) decreases evenly radially outwards towards the minimum tapering thickness (5) radially outward of the at least one material tapering (4),
so that an angle (7) of at most 15° is enclosed between two opposed tapered recess faces (28, 38) in the at least one material tapering (4).

6. The apparatus according to claim 5,
wherein in axial cross-section the blade (1) includes a pair of opposed tapered end faces (2) on respective axial sides that enclose an angle (7) toward the peripheral cutting edge (3),
which angle has the same size as the angle (7) enclosed by the tapered recess faces (28, 38) in the region of the at least one material tapering (4).

7. The apparatus according to claim 1,
wherein the at least one material tapering (4) extends in only on one axial side (12).

8. The apparatus according to claim 1,
wherein in axial cross section the cutting edge (3) is formed axially symmetrical to a central fastening region of the circular blade.

9. The apparatus according to claim 7,
wherein the cutting edge (3) is formed axially asymmetrically to a central fastening region of the circular blade (1).

10. Apparatus comprising:
a circular blade, wherein the circular blade is configured to cut material by rotation about an axis,
wherein the circular blade includes
a circular body, wherein the circular body includes
a first circular axial side and a second circular axial side opposed of the first circular axial side,
a central fastening region concentric with the axis,
a cutting edge, wherein the cutting edge is radially disposed outwardly from the axis,
a circular recess, wherein the circular recess
extends into the body on the first axial side,
is coaxial with the axis,
is radially intermediate of the central fastening region and the cutting edge, and
extends radially between an inner recess radius and outer recess radius,
wherein in axial cross-section
the first axial side includes a tapered end face,
wherein the tapered end face bounds the body and extends to the cutting edge,
wherein the tapered end face extends continuously closer to the second axial side with radially outward proximity to the cutting edge,
wherein the first axial side further includes a tapered recess face,
wherein the tapered recess face bounds the body within the recess, and
extends continuously closer to the second axial side from the inner recess radius with radially outward proximity to the outer recess radius.

11. The apparatus according to claim 10,
wherein the second axial side includes a further circular recess, wherein the further circular recess
extends into the body on the second axial side,
is coaxial with the axis,
is radially intermediate of the central fastening region and the cutting edge, and
extends radially between a further inner recess radius and a further outer recess radius,
wherein the further inner recess radius corresponds to the inner recess radius of the first axial side, and the further outer recess radius corresponds to the outer recess radius of the first axial side,
wherein in axial cross-section,
the second axial side includes a further tapered end face,
wherein the further tapered end face bounds the body and extends to the cutting edge,
wherein the further tapered end face extends continuously closer to the first axial side with radially outward proximity to the cutting edge,
wherein the second axial side further includes a further tapered recess face, wherein the further tapered recess face
bounds the body within the further recess, and
extends continuously closer to the first axial side from the further inner recess radius with radially outward proximity to the further outer recess radius.

12. The apparatus according to claim 11,
wherein in axial cross-section
the circular body includes
a taper thickness, wherein the taper thickness comprises a body thickness parallel to the axis,
wherein the body includes the taper thickness at a taper thickness radius that is disposed radially intermediate of the outer recess radius and the cutting edge, and wherein each of the first axial side and the second axial side extend continuously closer to the respective opposed axial side radially outward from the taper thickness radius with radially outward proximity to the cutting edge.

13. The apparatus according to claim 10,
wherein in axial cross-section,
the circular body includes,
a taper thickness, wherein the taper thickness comprises a body thickness parallel to the axis,
wherein the body includes the taper thickness at a taper thickness radius that is disposed radially intermediate of the outer recess radius and the cutting edge, and wherein the first axial side extends continuously closer to the second axial side radially outward from the taper thickness radius with radially outward proximity to the cutting edge.

14. The apparatus according to claim 12,
wherein the circular body further includes the taper thickness at the inner recess radius.

15. The apparatus according to claim 13,
wherein the circular body further includes the taper thickness at the inner recess radius.

16. The apparatus according to claim 14,
wherein the circular body includes a central fastening region thickness,
wherein the central fastening region thickness comprises a body thickness radially inward of the inner recess radius and parallel to the axis,
wherein the central fastening region thickness is greater than the taper thickness.

17. The apparatus according to claim 15,
wherein the circular body includes a central fastening region thickness,
wherein the central fastening region thickness comprises a body thickness radially inward of the inner recess radius and parallel to the axis,
wherein the central fastening region thickness is greater than the taper thickness.

18. The apparatus according to claim 16,
wherein in axial cross-section the tapered recess face of the first axial side and the further tapered recess face of the second axial side extend relative to one another at a convergent angle of 10° to 15° in the radially outward direction.

19. The apparatus according to claim 17,
wherein in axial cross-section the tapered recess face of the first axial side extends relative to the second axial side at a convergent angle of 10° to 15° in the radially outward direction.

20. The apparatus according to claim 18,
wherein in axial cross-section the tapered recess face and the further tapered recess face terminate at a minimum recess thickness radius,
wherein the body has a minimum recess thickness at the minimum recess thickness radius, wherein the minimum recess thickness comprises a body thickness parallel to the axis,
wherein the minimum recess thickness is less than the taper thickness, and
wherein an additional tapered recess face extends in the recess radially outward and in a first axial direction parallel to the axis from the minimum recess thickness radius to the outer recess radius, and wherein a further additional tapered recess face extends in the further recess radially outward and in a second axial direction parallel to the axis and opposed of the first axial direction from the minimum recess thickness radius to the further outer recess radius.

21. The apparatus according to claim 19,
wherein in axial cross-section the tapered recess face terminates at a minimum recess thickness radius,
wherein the body has a minimum recess thickness at the minimum recess thickness radius, wherein the minimum recess thickness comprises a body thickness parallel to the axis,
wherein the minimum recess thickness is less than the taper thickness, and
wherein an additional tapered recess face extends in the recess radially outward and in an axial direction parallel to the axis from the minimum recess thickness radius to the outer recess radius.

22. The apparatus according to claim 20,
wherein the body of the circular blade is configured to be ground to a successor cutting edge that extends radially outward from the minimum recess thickness after wearing of the cutting edge,
and wherein in axial cross-section a successor tapered end face extends continuously closer to the second axial side with radially outward proximity to the successor cutting edge,
and wherein in axial cross-section a successor further tapered end face extends continuously closer to the first axial side with radial outward proximity to the successor cutting edge,
and wherein the successor tapered end face includes the tapered recess face, and wherein the successor further tapered end face includes the further tapered recess face.

23. The apparatus according to claim 21,
wherein the body of the circular blade is configured to be ground to a successor cutting edge that extends radially outward from the minimum recess thickness after wearing of the cutting edge,
and wherein in axial cross-section a successor tapered end face extends continuously closer to the second axial side with radially outward proximity to the successor cutting edge,
and wherein the successor tapered end face includes the tapered recess face.

24. The apparatus according to claim 22,
wherein the circular body includes
an additional circular recess, wherein the additional circular recess extends into the body on the first axial side,
is coaxial with the axis,
is radially intermediate of the central fastening region and the recess radius, and
extends radially between an additional inner recess radius and an additional outer recess radius,
a further additional circular recess, wherein the further additional circular recess extends into the body on the second axial side,
is coaxial with the axis,
is radially intermediate of the central fastening region and the further inner recess radius, and
extends radially between a further additional inner recess radius and a further additional outer recess radius,
wherein the additional circular recess and the further additional circular recess are configured to be ground to form an additional successor cutting edge radially inward of the successor cutting edge.
